(19) United States
(12) Patent Application Publication
(10) Pub. No.: US 2017/0014285 A1
(43) Pub. Date: Jan. 19, 2017

(54) EMERGENCY MOBILE LABOR COT INSIDE AMBULANCE VANS

(71) Applicant: Gayathree Mohan, Chennai (IN)

(72) Inventor: Gayathree Mohan, Chennai (IN)

(21) Appl. No.: 15/301,232

(22) PCT Filed: Dec. 26, 2014
(86) PCT No.: PCT/IN2014/000799

§ 371 Date: Sep. 30, 2016

(30) Foreign Application Priority Data
Apr. 5, 2014 (IN) 1825/CHE/2014

(51) Int. Cl. A61G 1/02; A61G 15/00; A61G 1/056

(52) U.S. Cl. CPC A61G 1/0262; A61G 1/0206; A61G 1/0565; A61G 15/005

(57) ABSTRACT

Emergency mobile labor cot [20] inside ambulance is disclosed. The emergency mobile labor cot for providing healthcare to pregnant women at their doorstep according to the invention comprises a mainframe, adjustable headrest [1], a base structure with wheels [7,9,15], an actuator lever [4] for folding the legs, and an IV fluid stand [17]. The method of providing healthcare to the patient, comprises the steps of bringing the equipment down to the floor; strapping the patient with strap belts; lifting the equipment to convert it into a labor cot; putting in place the side guards; wheeling the patient into the ambulance; pressing the actuating lever to align the legs of the COT to sit inside the rails fitted inside the ambulance; locking of the mobile labor cot inside the ambulance van using the automatic locking mechanism; fitting the foot straps into the slop; adjusting the sterilized tray; opening the screen for privacy; taking the delivery kit out and performing the delivery with the doctor.

### FIELD OF THE INVENTION

The field of this invention relates to emergency labor cots, and more particularly to an improved emergency labor cot having a wheeled transporter to facilitate mobility.

### BACKGROUND OF THE INVENTION

Healthcare for pregnant women is not available in remote, rural and hilly areas easily. Therefore, access to the nearest healthcare facility becomes very difficult through rough roads.

Currently women in labor are transported to the health care centers and there is no solution which involves no transport of the pregnant women.

Women in urban slums also lack the means to access healthcare during labor. Rural areas usually face high rate of maternal mortality and female foeticide. Women in the rural areas, when they are into labour pain either call the emergency or take other means of transport to reach the healthcare centers which may be situated very far away. Commutation is a problem faced by the women. The transition time to reach the healthcare centers sometimes complicates the delivery. For most rural people the first point of contact for medical care is Primary Health Care Centre (PHC). The pregnant ladies in these areas access PHCs. Several factors like difficulty in accessing PHC for delivery are a major problem. Access to Hospitals for child delivery on time remains a critical problem for rural women with an average of 20 km travel over rough roads to reach the nearest Hospital. The tyranny of distance and lack of transport are major impediments to safe delivery of baby.

There is a recognized need in the art for an improved apparatus and method which will enable emergency labor healthcare at their doorstep. The present invention fulfills this long standing need in the art.

### SUMMARY OF THE INVENTION

An object of the present invention is to provide safe delivery on any road where an ambulance can be parked.

Another object of the present invention is to provide a mobile maternity ward to pregnant women where safe delivery can be performed at their doorstep.

Another object of the present invention is to provide healthcare to pregnant women in urban slums and who cannot afford transportation costs.

Accordingly, to meet the objects of the invention, disclosed herein is a method, comprising the steps of: bringing down the equipment for easy transfer of the patient; strapping the strap belts to the patient; lifting the equipment to convert it into a LABOR COT ON WHEELS; putting in place of the side guards; wheeling the patient into the ambulance van; pressing the actuating lever to align the legs inside the rails fitted inside the ambulance; locking the mobile labor cot inside the ambulance van using the automatic locking mechanism; fitting the foot strap into the slot and adjusting the height according to the comfort of the patient; adjusting of the sterilized tray depending on the height of the patient; opening of the screen for privacy; taking the delivery kit outside and performing the delivery.

In accordance with an embodiment of the invention, disclosed herein is an emergency labor cot for use in the location where the pregnant women is located, said emergency delivery cot comprising a mainframe; an adjustable head rest; two side guards for the safety of the patient; a patient strap belt for patient safety; a 3 inch puff cushion; a foot strap; a tray; a main handle; two side main links; a spring loaded main link locks; a main link cross flat; an actuating lever capable of bringing the cot to ground level by folding the legs after undoing the link locks; a rear leg assembly fitted with two pillar wheels capable of 360 degree rotation for easy movement; a front leg assembly fitted with two non-rotating wheels to guide movement of trolley; 2 rubber castor wheels for guiding the cot inside the ambulance van; a leg cross pipe connecting the front leg assembly and rear leg assembly; a head rest gas spring for adjusting the head rest; an IV fluid stand; a foldable screen for privacy and an automatic locking mechanism located in the rails of the ambulance for use with the said emergency labor cot.

### BRIEF DESCRIPTION OF THE DRAWINGS

Referring now to the drawings wherein the showings are for the purpose of illustrating embodiments of the inventions only, and not for the purpose of limiting the same.

FIG. 1 illustrates an emergency mobile labor cot inside ambulance.

FIG. 2 illustrates the method of using the equipment by means of a flowchart

### REFERENCE NUMERALS IN DRAWINGS

1—Adjustable Head rest

2—Patient Strap Belt

3—Side guards

4—3 inch puff cushion

5—Actuating lever

6—Rear leg assembly

7—360 degree revolving wheels

8—Front leg assembly

9—Non rotating wheels

10—Leg cross pipe

11—Side main link

12—Spring loaded main link locks

13—Main link cross flat

14—Idle wheels

15—Additional handle

16—Head rest gas spring

17—IV fluid stand

18—Main Frame Handle

### DETAILED DESCRIPTION OF THE INVENTION

“labor” as mentioned herein is ‘the process of childbirth’.

The present invention will be described herein below with reference to the accompanying drawing. The present invention provides an emergency mobile labor cot inside ambulance.

The labor cot [20] is made of mild steel pipes and sections. It moves on rails fitted inside the ambulance van.

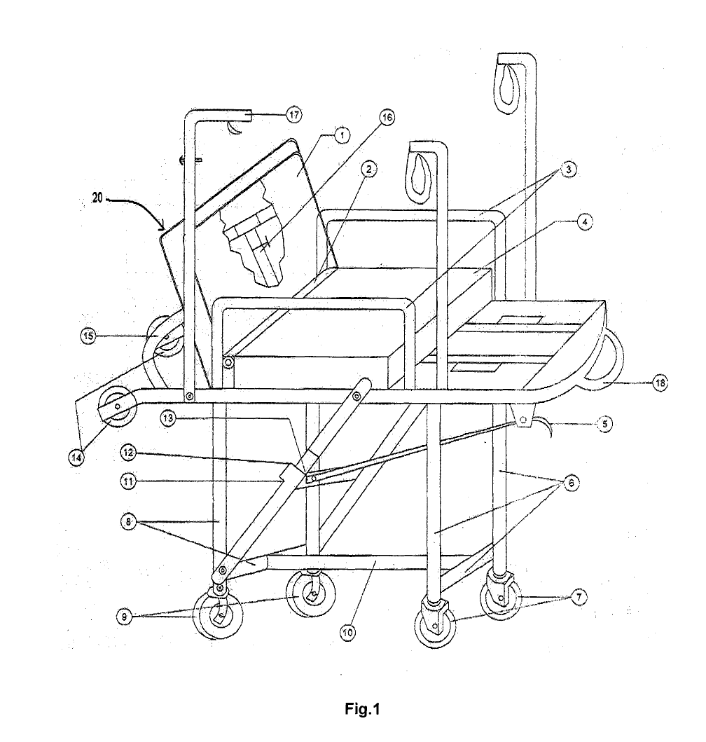

A preferred embodiment of the emergency labor cot [20] is shown in FIG. 1. The labor cot [20] has a mainframe, an adjustable headrest [1] which moves from 90 degree to 180 degree, side guards [3] for the safety of the patient, patient strap belts [2] for patient safety, a 3 inch puff cushion [4] and foot straps. The puff cushion [4] and the foot straps are both removable and height adjustable according to the height of the pregnant women. It also has a removable, reusable, washable tray which can be moved back and forth depending on the height of the pregnant women. It also has a main handle [18] with which the entire labor cot can be pulled to position for optimum use. There are two side main links [11] which is spring loaded [12] and are connected by the main link cross flat [13] and helps in the conversion of the stretcher to the trolley mode. There are 6 rubber castor wheels [7,9,14], two of which are idle wheels [14] to guide the cot inside the ambulance van, two are pillar wheels [7] capable of 360 degree rotation for easy movement and two are non-rotatable rubber wheels [9] to guide the movement of the trolley. The labor cot has a rear leg assembly [6] fitted with two pillar wheels [7] and a front leg assembly [8] fitted with two non rotating wheels [9]. There is a leg cross pipe [10] connecting the front leg assembly [8] and rear leg assembly [6]. A head rest gas spring [16] is used to adjust the head rest [1]. Labor cot can be brought down to the ground level using an actuating lever [5] where the legs fold after the link locks are undone. This makes it convenient to transfer pregnant women lying in the floor. Labor cot also has an Intravenous fluid stand [17], a foldable screen for privacy and an essential delivery kit containing drugs and accessories needed for delivery. There is also an automatic locking mechanism which holds the mobile labor cot in place located in the rails inside the ambulance van to ensure that the equipment does not come out of the van during transportation.

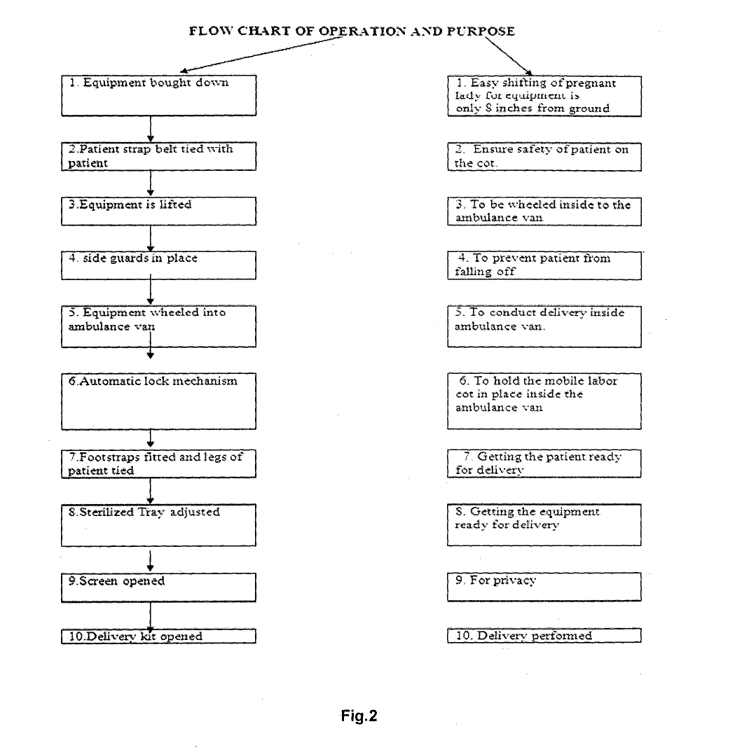

The method of using the equipment is shown in FIG. 2 and explained in the following steps:
1) The equipment is brought down to the floor and the pregnant women can be easily shifted/transferred onto the equipment which will be only 8 inches from the ground/floor.
2) Patient strap belts can be strapped on for the safety of the pregnant women.
3) The equipment is then lifted and it becomes a LABOR COT ON WHEELS
4) The side guards are put in place to prevent the patient from falling off the cot thus giving the patient a feeling of security.
5) The pregnant women can be wheeled into the ambulance van and when the idle wheel of the equipment touches the floor of the ambulance van, the actuating lever is pressed so that the legs of the LABOR COT/TROLLEY sits inside the rails fitted inside the ambulance van.
6) There is an automatic locking mechanism inside the ambulance with a lock plate and spring mechanism which holds the mobile labor cot inside the ambulance van.
7) The foot straps are fitted into the slot and its height is adjusted according to the comfort of the pregnant women whose legs are tied for delivery.
8) The sterilized tray is then adjusted back and forth depending on the height of the patient.
9) The screen is then opened and kept outside the van for privacy.
10) The delivery kit is then taken out and the delivery is performed with the doctor at the rear of the ambulance and a patient attendant inside the ambulance van.

The foregoing description is for an embodiment of the present invention. It should be appreciated that these embodiments are described for purpose of illustration only, and that numerous alterations and modifications may be practiced by those skilled in the art without departing from the spirit and scope of the invention. It is intended that all such modifications and alterations be included insofar as they come within the scope of the invention as claimed or the equivalents thereof.

Other modifications will be apparent to those skilled in the art and, therefore, the invention is defined in the claims.

1. An emergency labor cot for use in the location where the pregnant women is located, said emergency labor cot comprising a mainframe; an adjustable head rest; two side guards for the safety of the patient; a patient strap belt for patient safety; a 3 inch puff cushion; two foot straps wherein the said foot straps are removable and height adjustable according to the height of the patient; a tray; a main handle; two side main links; a spring loaded main link locks; a main link cross flat; an actuating lever capable of bringing the cot to ground level by folding the legs after undoing the said link locks; a rear leg assembly fitted with two pillar wheels capable of 360 degree rotation for easy movement; a front leg assembly fitted with two non-rotating wheels to guide movement of trolley; 2 rubber castor wheels for guiding the cot inside the ambulance van; a leg cross pipe 10 connecting the front leg assembly 8 and rear leg assembly; a head rest gas spring for adjusting the head rest; an IV fluid stand; and a foldable screen for privacy.

2. An emergency labor cot as claimed in claim 1 wherein said head rest is capable of moving 90 degrees to 180 degrees.

3. An emergency labor cot as claimed in claim 1 wherein said puff cushion is removable and height adjustable according to the height of the patient.

4. An emergency labor cot as claimed in claim 1 wherein said tray is removable, reusable and washable, and capable of moving back and forth depending on the height of the patient.

5. An emergency labor cot as claimed in claim 1 wherein said main handle is used to pull and position the entire labor cot for optimum use.

6-8. (canceled)
